(19) United States
(12) Patent Application Publication
(10) Pub. No.: US 2009/0205504 A1
(43) Pub. Date: Aug. 20, 2009

(54) CAPSULE CONTAINER DESIGNED FOR THE PREPARATION OF HOT DRINKS

(76) Inventor: Francisco Navarro Alcantara, Sabadell (ES)

Correspondence Address: YOUNG & THOMPSON, 209 Madison Street, Suite 500, ALEXANDRIA, VA, 22314, US

(21) Appl. No.: 12/304,901

(22) PCT Filed: Jun. 12, 2007
(86) PCT No.: PCT/ES2007/000349

§ 371 Date: Dec. 15, 2008

(30) Foreign Application Priority Data
Jun. 13, 2006 (ES) P200601591

(51) Int. Cl. A47J 31/44; B65D 53/00

(52) U.S. Cl. 99/295; 220/361

(57) ABSTRACT

A capsule container of the type used to store non-sealed capsules containing products that are used to prepare hot drinks in self-service machines. The invention is essentially characterised in that it consists of a rigid cup-type container with non-porous walls (1), the mouth of which is closed with a barrier film of aluminum or plastic (2) that can be removed manually from the cup and easily perforated. The interior of the aforementioned cup loosely houses at least one non-sealed capsule (3) in an inert atmosphere, the non-sealed capsule (3) containing food substances (4) suitable for the preparation of hot drinks.

### TECHNICAL FIELD

The present invention relates to a means to hermetically contain one or more non-hermetically sealed capsules, which in turn contain products for the preparation of hot drinks in automatic or manual self-service machines.

### BACKGROUND OF THE INVENTION

The non-hermetically sealed capsules designed to serve in the preparation by percolation of a hot drink, contain a pre-established dose of a food substance which can be combined with hot water injected at high pressure using a machine to prepare the drinks.

These capsules can be of two types: hermetically sealed or non-hermetically sealed.

In order to preserve the organoleptic characteristics of their content for a long time, non-hermetically sealed capsules are packaged in sealed bags of flexible material and within an inert gas atmosphere, thus avoiding oxidation of the product contained.

These capsules are used in manual load machines, wherein they are introduced by the user after being removed from their wrapping.

In general, each capsule is designed in accordance with the machine where it is to be used, its use being impossible in machines which are not specific of the manufacturer.

On the other hand, it is impossible to use it in automatic machines to dispense hot drinks, such as for example, that disclosed in Spanish patent no. P200201558 PROCESS, MACHINE AND PACK FOR THE PREPARATION AND DISPENSING OF HOT AND COLD DRINKS, since the capsule must always be removed from the bag manually.

For use in automatic machines, it is necessary that the food product is contained in a hermetically-sealed rigid capsule, such as, for example, that disclosed in utility model no. U0153070 CAPSULE TO CONTAIN SUBSTANCES DESIGNED TO PREPARE DRINKS, or in the aforementioned patent no. P200201558.

In turn, these hermetically-sealed capsules are incompatible with all those machines designed to operate with non-hermetically sealed capsules, both due to the geometry of the capsules and the operation of the water injection systems.

The incompatibility between the different capsules for the preparation of hot drinks that exist on the market, favour the scarceness of these products, since it is necessary to package the material to be combined with water in different capsule models to be able to use them in any type of machine, although it should be mentioned that the automatic drink loading and dispensing devices are those which are most widespread, given the circumstance that in these machines there is important compatibility between the devices of different manufacturers.

### DESCRIPTION OF THE INVENTION

In general terms, the present invention relates to a container for non-hermetically sealed capsules as replacement for the flexible packaging bags, which permits the use of these capsules both in those manual machines for which they were designed, and in automatic machines where by themselves they are not compatible.

The novel device consists of a receptacle by way of cup with non-porous walls closed at its mouth by a film of aluminium or barrier plastic, manually removable or it can be easily perforated, wherein is housed, in an inert atmosphere and loosely for its removal without tools, at least one non-hermetically sealed capsule containing substances suitable for the preparation of hot drinks.

The base of the cup is made so that it can also be easily perforated, so that the injection and extraction means of the water included in the automatic self-service machines for the preparation of drinks can act thereon without problems. To do this, the outer geometry of the container cup, corresponds to that of a conventional capsule of the type used in self-service machines or is compatible by basic dimensions therewith.

The insertion of the non-hermetically sealed capsule in the cup is carried out so that its upper surface is positioned at the level of or below the threshold of the cup mouth, to configure a small pre-infusion chamber between the sealing film and the upper surface of the capsule.

On the other hand, the inside of the container includes one or more fixing areas of the capsule, which form one or more closure lines designed to force the water injected through the upper part of the container to pass through the capsule to finally exit through the lower part of the container.

The fixing areas of the capsule may basically be situated in the upper area of the cup, on the lower or on both.

The fixing area on the upper part of the cup is formed by a peripheral flange preferably configured by an inclined annular plane whereon a peripheral flange rests, a flange which practically all non-hermetically sealed capsules have in their uppermost part.

The fixing area on the lower part of the cup is formed by a pinching of the cup walls or a peripheral groove on the base thereof, where the lower peripheral edge of the outer wall of the capsule will be interlocked.

According to the aforementioned, thus, the non-hermetically sealed capsule may have two positions within the container according to its state of use, one corresponding to the storage situation of the assembly and the other to use in an automatic machine.

In the storage position, the capsule simply rests on the fixing areas of the container, having in said position, sufficient clearance for its removal. In this position, a user who has a manual hot drink making machine will proceed to remove the sealing film from the container preferably using a tab provided for this purpose, and removing the capsule therefrom with the need to use tools.

In the position of use, the capsule is interlocked in the two fixing areas of the container, this effect occurring when through the feed mechanism of the drink making machine, the container, containing the non-hermetically sealed capsule, reaches the water injection area, wherein, the machine will automatically tear or puncture the sealing film of the container to inject therein hot water at high pressure, which will completely flood the pre-infusion chamber and will exert sufficient pressure on the capsule to move it downwards until favouring its interlocking in the upper and lower fixing area of the container. In said situation, all the water which is injected in the pre-infusion chamber is evacuated through the capsule, which will be closed to the passage through the area between the inner wall of the container and outer wall of the capsule. The water is mixed with the substance contained in the capsule in the same way as if it was inserted in a manual machine, and it re-enters a lower chamber which is limited by the lower surface of the capsule and of the container, from where it finally flows through perforations made in the base of the container by the drink making machine.

In specific makings, the contained capsules can be o a material not rigid, being bags or similar.

Finally, it is noteworthy that the final configuration of the container allows their stacking in columns so that they can be placed in the storage areas of the automatic machines.

### DESCRIPTION OF THE DRAWINGS

In order to illustrate the aforementioned, the present specification is accompanied by a sheet of drawings which represents an example of embodiment, which is merely illustrative and not limitative of the practical possibilities of the invention.

In said drawings:

FIG. 1 corresponds to a sectional view of the novel container in open position.

FIG. 2 corresponds to a sectional view of the container in position of use in an automatic machine.

FIG. 3 corresponds to a view of several units of the invention stacked as if they were positioned in an automatic self-service machine.

FIG. 4 corresponds to an exploded view of the assembly.

### DESCRIPTION OF AN EMBODIMENT

The novel capsule container designed for the preparation of hot drinks consists of a receptacle by way of a cup with non-porous walls (2) closed at its mouth by an aluminium film (2), wherein a non-hermetically sealed capsule (3) containing coffee (4) is housed in an inert atmosphere and loosely.

The insertion of the non-hermetically sealed capsule (3) inside the cup (1) is performed so that its upper surface is positioned below the threshold of the cup mouth, configuring a small chamber (5) between the sealing film (2) and the upper surface of the capsule (3).

The inside of the container has two fixing areas of the capsule, one located in the upper part of the cup, formed by a peripheral flange configured by an inclined annular plane (6) whereon there rests a peripheral flange (7) that the non-hermetically sealed capsule (3) that has in its upper part, and another in the lower part, formed by a peripheral groove (8) into which the lower peripheral edge (9) of the outer wall of the capsule interlocks.

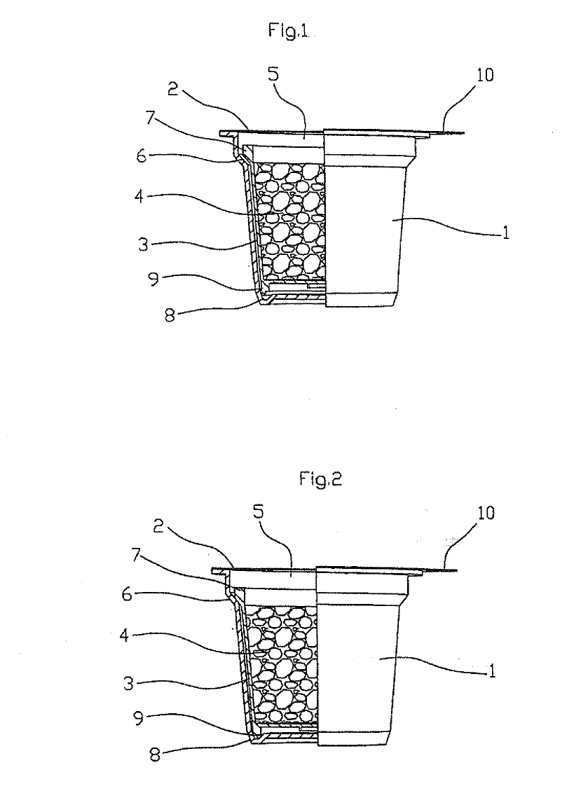

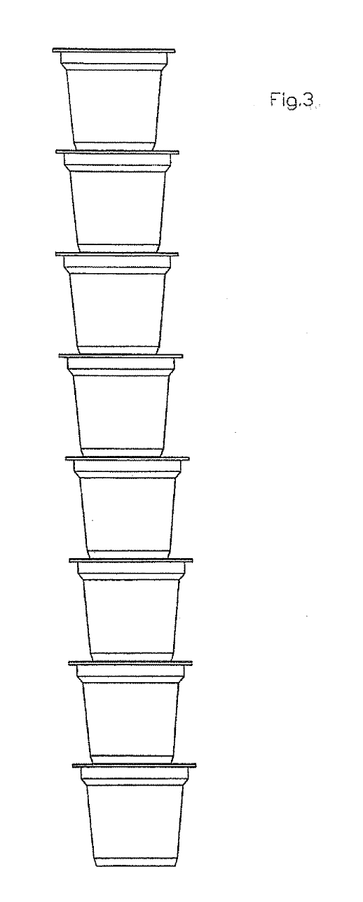

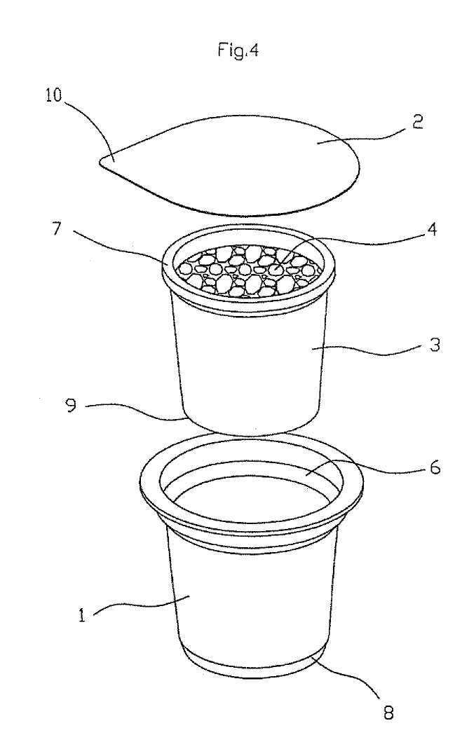

The capsule (3) can be placed in two positions within the cup (1), one corresponding to the storage situation of the assembly (FIG. 1) and the other to that of use in an automatic machine (FIG. 2).

In the storage position (FIG. 1) the capsule simply rests on the fixing areas of the container (6) and (8), in said position having sufficient clearance for its extraction.

In this position, a user which uses the novel device in a manual hot drink making machine will remove the sealing film (2) from the container (1) using a tab (10) incorporated with the film, and removing the capsule (3) due to gravity therein.

In the position of use (FIG. 2), the capsule (3) is interlocked in the two fixing areas of the container (6) and (8), this effect occurring when the invention is used in an automatic drink making machine, which injects pressurized water in the chamber (5), moving the capsule (3) towards the bottom of the cup (1) until favouring its interlocking in the upper (6) and lower (8) fixing areas of the container.

In said situation, all the water which is injected in the chamber (5) is evacuated through the capsule (3) and drags dissolving the coffee (4) and re-enters a lower chamber (11) delimited by the lower surface of the capsule and the container, wherefrom it finally flows through one of the perforations made in the container by the drink making machine.

Finally, it is noteworthy that the final configuration of the container enables their stacking in columns so that they can be placed in the storage areas of the automatic machines.

1. “Capsule container” of the type used to preserve non-hermetically sealed capsules containing in turn products for the preparation of hot drinks in self-service machines, essentially characterized in that it consists of a rigid receptacle by way of a cup with non-porous walls (1) closed at its mouth by a film of aluminium or barrier plastic (2), manually removable from the cup and it can be easily perforated, wherein is housed, in an inert atmosphere and loosely, at least one non-hermetically sealed capsule (3) containing food substances (4), suitable for the preparation of hot drinks.

2. “Capsule container” according to claim 1, characterized in that the base of the cup (1) is configured so that it can be easily perforated.

3. “Capsule container” according to claim 1, characterized in that the outer geometry of said rigid receptacle by way of a cup (1), basically corresponds to that of a conventional hermetically-sealed capsule of the type used in self-service machines or is compatible by basic dimensions therewith.

4. “Capsule container” according to claim 1, characterized in that the insertion of the non-hermetically sealed capsule (3) in the cup (1) is carried out so that its upper surface is positioned at the level of or below the threshold of the cup mouth, to configure a small pre-infusion chamber (5) between the sealing film (2) and the upper surface of the capsule (3)

5. “Capsule container” according to claim 1, characterized in that the inside of the rigid receptacle by way of a cup (1) container includes one or two fixing areas of the capsule, which form two closure lines designed to force the water injected through the upper part of the container to pass through the capsule to finally exit through the lower part thereof.

6. “Capsule container” according to claim 1, characterized in that one of the two fixing areas of the capsule is positioned in the upper part of the cup (1), formed by a peripheral flange (6) whereon a peripheral flange (7) that the non-hermetically sealed capsules have in their uppermost part rests.

7. “Capsule container” according to claim 1, characterized in that the perimeter flange (6) is preferably configured by an annular inclined plane.

8. “Capsule container” according to claim 1, characterized in that one of the two fixing areas of the capsule is positioned in the lower area of the cup (1), formed by a pinching of the cup walls or a peripheral groove on the base thereof (8), where the lower peripheral edge (9) of the outer wall of the capsule will be interlocked.

9. “Capsule container” according to claim 1, characterized in that the capsule (3) can be established in two positions within the cup (1), one corresponding to the storage situation of the assembly wherein it simply rests on the fixing areas of the container (6) and/or (8), having in said position sufficient clearance for its removal, and another corresponding to that of use in an automatic machine, wherein the capsule (3) is interlocked in the fixing areas of the container (6) and/or (8) by the action of water injected in the pre-infusion chamber (5), exerting on the capsule a pressure which displaces its downwards until favouring its interlocking.

10. “Capsule container” according to claom 1, characterized in that the sealing film (2) has a tab (10) to facilitate its removal from the mouth of the cup (1).

11. “Capsule container” according to claim 1, characterized in that the capsule is not a rigid type, like a bag for infusions.

12. “Capsule container” according to claim 2, characterized in that the capsule is not a rigid type, like a bag for infusions.
